(19) United States
(12) Patent Application Publication
(10) Pub. No.: US 2024/0282018 A1
(43) Pub. Date: Aug. 22, 2024

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: NEC Corporation, Minato-ku, Tokyo (JP)

(72) Inventors: Tetsuya FUYUNO, Tokyo (JP); Masahiro KOUCHI, Tokyo (JP)

(73) Assignee: NEC Corporation, Minato-ku, Tokyo (JP)

(21) Appl. No.: 18/569,307

(22) PCT Filed: Jun. 17, 2021
(86) PCT No.: PCT/JP2021/023088

§ 371 Date: Dec. 12, 2023

(51) Int. Cl. G06T 11/00; G06F 3/01; G06F 3/16; G06T 7/70; G06V 20/20

(52) U.S. Cl. CPC G06T 11/00; G06F 3/011; G06F 3/165; G06T 7/70; G06V 20/20; G06T 2207/30196

(57) ABSTRACT

An information processing apparatus includes a selecting unit that selects one of a plurality of operating modes according to a predetermined condition, an image acquisition unit that acquires a photographed image generated by photographing a user's view by a user terminal, an element-of-interest detection unit that detects a predetermined element of interest in the photographed image, a generation unit that generates superimposition information related to the element of interest at least based on identification information of the element of interest and a type of the selected operating mode, and an output control unit that makes the user terminal display the superimposition information in such a manner that the superimposition information overlaps a view area indicating the user's view.

### TECHNICAL FIELD

The present disclosure relates to an information processing apparatus, an information processing system, an information processing method, and a non-transitory computer readable medium. In particular, the present disclosure relates to an information processing apparatus, an information processing system, an information processing method, and a non-transitory computer readable medium for providing information about an element of interest to a user.

### BACKGROUND ART

A method for, when a tourist approaches an exhibit, providing information about the exhibit to the tourist has been proposed. For example, Patent Literature 1 discloses a method for making a portable terminal apparatus carried by a visitor to an archaeological site acquire element information about an exhibit through short-range radio communication and display the element information by superimposing it on a live image of an environment (i.e., a live image of an area around the exhibit) or a real-scene image thereof.

### CITATION LIST

### Patent Literature

Patent Literature 1: Japanese Unexamined Patent Application Publication No. 2004-102835

### SUMMARY OF INVENTION

### Technical Problem

However, in the above-described method disclosed in Patent Literature 1, the same information related to an exhibit exhibited in front of visitors is provided to all the visitors in the same manner, and it is not possible to provide different information to each visitor or provide information which differs according to a contract plan.

In view of the above-described problem, an object of the present disclosure is to provide an information processing apparatus, an information processing system, an information processing method, and a non-transitory computer readable medium capable of, when providing information related to an object that has come into a user's field of view (hereinafter also referred to simply as the user's view or the like) to the user, providing information which differs according to the situation to the user.

### Solution to Problem

An information processing apparatus according to an aspect of the present disclosure includes:
selecting means for selecting one of a plurality of operating modes according to a predetermined condition;
image acquisition means for acquiring a photographed image generated by photographing a user's view by a user terminal;
element-of-interest detection means for detecting a predetermined element of interest in the photographed image;
generation means for generating superimposition information related to the element of interest at least based on identification information of the element of interest and a type of the selected operating mode; and
output control means for making the user terminal display the superimposition information in such a manner that the superimposition information overlaps a view area indicating the user's view.

An information processing system according to an aspect of the present disclosure includes:
a user terminal used by a user and configured to photograph a user's view; and
an information processing apparatus, in which
the information processing apparatus includes:
selecting means for selecting one of a plurality of operating modes according to a predetermined condition;
image acquisition means for acquiring a photographed image generated by the user terminal;
element-of-interest detection means for detecting a predetermined element of interest in the photographed image;
generation means for generating superimposition information related to the element of interest at least based on identification information of the element of interest and a type of the selected operating mode; and
output control means for making the user terminal display the superimposition information in such a manner that the superimposition information overlaps a view area indicating the user's view.

An information processing method according to an aspect of the present disclosure includes:
selecting one of a plurality of operating modes according to a predetermined condition;
acquiring a photographed image generated by photographing a user's view by a user terminal;
detecting a predetermined element of interest in the photographed image;
generating superimposition information related to the element of interest at least based on identification information of the element of interest and a type of the selected operating mode; and
making the user terminal display the superimposition information in such a manner that the superimposition information overlaps a view area indicating the user's view.

A non-transitory computer readable medium according to an aspect of the present disclosure stores a program for causing a computer to perform:
a selection process for selecting one of a plurality of operating modes according to a predetermined condition;
an image acquisition process for acquiring a photographed image generated by photographing a user's view by a user terminal;
an element-of-interest detection process for detecting a predetermined element of interest in the photographed image;
a generation process for generating superimposition information related to the element of interest at least based on identification information of the element of interest and a type of the selected operating mode; and
an output control process for making the user terminal display the superimposition information in such a manner that the superimposition information overlaps a view area indicating the user's view.

### Advantageous Effects of Invention

According to the present disclosure, it is possible to provide an information processing apparatus, an information processing system, an information processing method, and a non-transitory computer readable medium capable of, when providing information related to an object that has come into the user's view to the user, providing information which differs according to the situation to the user.

### BRIEF DESCRIPTION OF DRAWINGS

FIG. 1 is a block diagram showing a configuration of an information processing apparatus according to a first example embodiment;

FIG. 2 is a flowchart showing a flow of an information processing method according to the first example embodiment;

FIG. 3 is a block diagram showing an overall configuration of an information processing system according to a second example embodiment;

FIG. 4 is a block diagram showing a configuration of a first user terminal according to the second example embodiment;

FIG. 5 is a block diagram showing a configuration of a second user terminal according to the second example embodiment;

FIG. 6 is a block diagram showing a configuration of a server according to the second example embodiment;

FIG. 7 is a diagram for explaining operating modes according to the second example embodiment;

FIG. 8 shows an example of a data structure of edition information according to the second example embodiment;

FIG. 9 is a sequence diagram showing a flow of a user registration process according to the second example embodiment;

FIG. 10 shows an example of a screen for entering personal information displayed on the second user terminal according to the second example embodiment;

FIG. 11 shows an example of an input screen for contract information displayed on the second user terminal according to the second example embodiment;

FIG. 12 is a sequence diagram showing a flow of an output process according to the second example embodiment;

FIG. 13 shows an example of a case where an element of interest is present in the field of view of a plurality of users;

FIG. 14 shows an example of superimposition information displayed on the first user terminal according to the second example embodiment;

FIG. 15 shows an example of superimposition information displayed on the first user terminal according to the second example embodiment;

FIG. 16 shows an example of superimposition information displayed on the first user terminal according to the second example embodiment;

FIG. 17 is a block diagram showing a configuration of a server according to a third example embodiment;

FIG. 18 is a diagram for explaining a process for detecting a selecting operation according to the third example embodiment;

FIG. 19 is a sequence diagram showing a flow of an output process according to the third example embodiment;

FIG. 20 is a diagram for explaining operating modes according to the fourth example embodiment;

FIG. 21 shows an example of superimposition information displayed on a first user terminal according to the fourth example embodiment; and

FIG. 22 shows an example of an input screen for a degree of importance of personal information displayed on a second user terminal according to a fifth example embodiment.

### EXAMPLE EMBODIMENT

An example embodiment according to the present disclosure will be described hereinafter in detail with reference to the drawings. Components corresponding to or the same as each other are assigned the same or corresponding numerical numbers (or symbols) throughout the drawings, and redundant descriptions thereof are omitted as appropriate for clarifying the explanation.

### First Example Embodiment

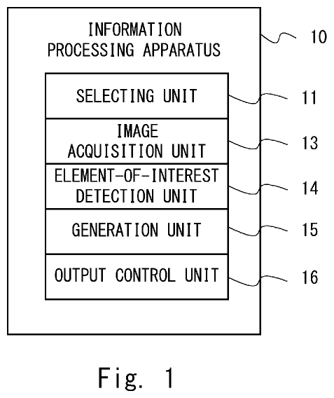

Firstly, a first example embodiment according to the present disclosure will be described. FIG. 1 is a block diagram showing a configuration of an information processing apparatus 10 according to the first example embodiment.

The information processing apparatus 10 is an information processing apparatus that provides information related to an element of interest that has come into the user's view to the user. The element of interest may be a building, an art object, an exhibit, or the like. In this case, the element of interest may also be referred to as an object of interest. Alternatively, the element of interest may be an archaeological site, scenery, or the like. In this case, the element of interest may also be referred to as scenery of interest. The element of interest is determined in advance. Note that the information processing apparatus 10 is connected to a network (not shown). The network may be a wired or wireless network. Further, a user terminal (not shown) used by a user is directly or indirectly connected to the network. That is, the information processing apparatus 10 is connected to the user terminal so that they can communicate with each other.

The information processing apparatus 10 includes a selecting unit 11, an image acquisition unit 13, an element-of-interest detection unit 14, a generation unit 15, and an output control unit 16.

The selecting unit 11 is also referred to as selecting means. The selecting unit 11 selects one of a plurality of operating modes according to a predetermined condition. The predetermined condition may be that a user has made a predetermined contract with a service provider that provides information or that a user has performed a predetermined selecting operation. Then, the selecting unit 11 notifies the generation unit 15 of the type of the selected operating mode.

The image acquisition unit 13 is also referred to as image acquisition means. The image acquisition unit 13 acquires a photographed image showing a user's view. The photographed image is a photographed image generated by photographing a user's view by a user terminal. The image acquisition unit 13 supplies the acquired photographed image to the element-of-interest detection unit 14.

The element-of-interest detection unit 14 is also referred to as element-of-interest detection means. The element-of-interest detection unit 14 detects a predetermined element of interest in the photographed image. Then, the element-of-interest detection unit 14 specifies identification information (ID) of the detected element of interest. The element-of-interest detection unit 14 supplies the ID of the element of interest to the generation unit 15.

The generation unit 15 is also referred to as generation means. The generation unit 15 generates superimposition information related to the element of interest at least based on the ID of the element of interest and the type of the selected operating mode. The superimposition information is image information. The image information may be a still image or a moving image. The superimposition information may include text data. The generation unit 15 supplies the superimposition information to the output control unit 16.

The output control unit 16 is also referred to as output control means. The output control unit 16 makes (e.g., instructs) the user terminal display the superimposition information in such a manner that the superimposition information overlaps a view area indicating the user's view.

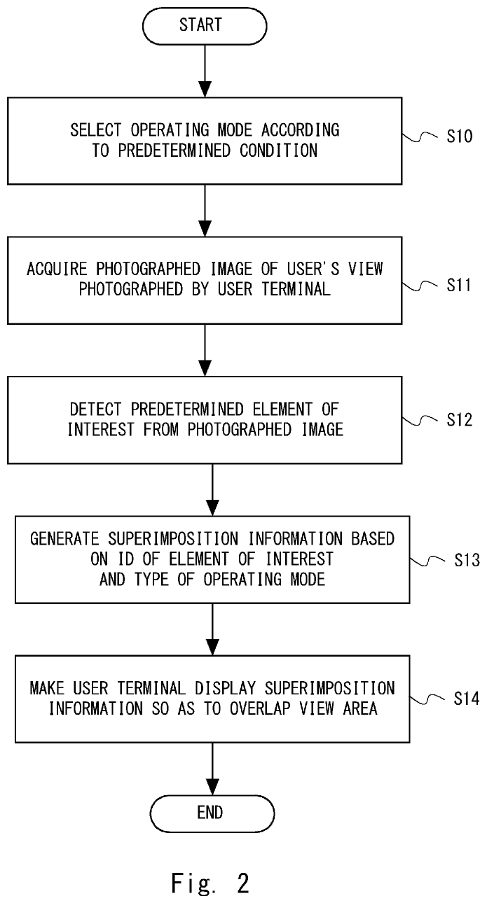

FIG. 2 is a flowchart showing a flow of an information processing method according to the first example embodiment. Firstly, the selecting unit 11 of the information processing apparatus 10 selects an operating mode according to a predetermined condition (S10). Next, the image acquisition unit 13 acquires a photographed image of a user's view photographed by the user terminal (S11). Next, the element-of-interest detection unit 14 detects a predetermined element of interest in the photographed image and specifies the ID of the element of interest (S12). Next, the generation unit 15 generates superimposition information related to the element of interest based on the ID of the element of interest and the type of the selected operating mode (S13). Next, the output control unit 16 makes (e.g., instructs) the user terminal display the superimposition information in such a manner that the superimposition information overlaps the view area of the user (S14).

As described above, according to the first example embodiment, when the information processing apparatus 10 provides information related to an element of interest that has come into a user's view to the user, it changes the information to be provided according to the operating mode. In this way, the information processing apparatus 10 can provide information which differs according to the situation to the user. Therefore, for example, by changing the amount of information, the quality of information, or how to provide information according to the contract plan or the money-paying situation, it is possible to induce a user to subscribe to an upgraded contract plan or to pay more money (or deposit more money).

### Second Example Embodiment

Next, a second example embodiment according to the present disclosure will be described.

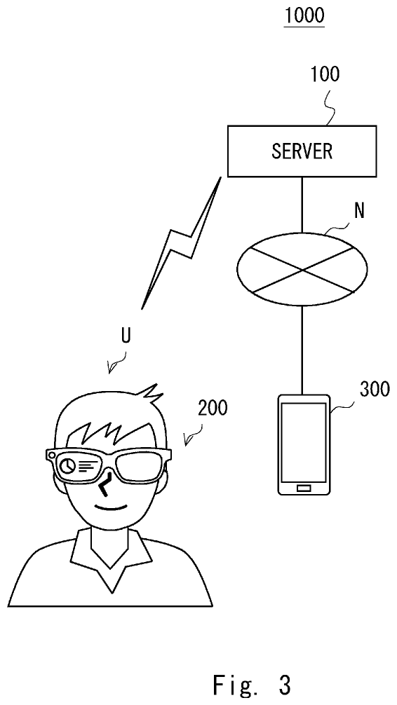

FIG. 3 is a block diagram showing an overall configuration of an information processing system 1000 according to the second example embodiment. The information processing system 1000 is a computer system by which a service provider provides services to users such as tourists or visitors. Note that services are those in which information related to an element of interest that has come into a user's view is provided. The information processing system 1000 includes an information processing apparatus (hereinafter referred to as a server) 100 and (a group of) user terminals used by users U. The (group of) user terminals include a first user terminal 200 and a second user terminal 300. The server 100 and the first user terminal 200 are connected to each other through a mobile communication network. For example, the server 100 and the first user terminal 200 are connected to each other by local 5G. The server 100 and the second user terminal 300 are connected to each other through a network N. Note that the network N is a wired or wireless communication line.

The first user terminal 200 is a wearable terminal attached to the body of a user U. For example, the first user terminal 200 is a wearable terminal attached to the head of the user U. As an example, the first user terminal 200 is a spectacle-type terminal such as AR (Augmented Reality) glasses or MR (Mixed Reality) glasses that can display image information, as superimposition information, in a view area indicating the view of the user U. The superimposition information may include text data. Further, the superimposition image may be a still image or a moving image. The superimposition image may include a text image. The first user terminal 200 photographs the view of the user U and transmits the photographed image to the server 100. Further, the first user terminal 200 displays superimposition information received from the server 100 in the view area of the user U in a superimposed manner. Further, the first user terminal 200 outputs voice output information received from the server 100 in addition to displaying the superimposition information.

The second user terminal 300 is an information terminal such as a smartphone, a tablet-type terminal, or a personal computer (PC) used by the user U. The second user terminal 300 registers personal information of the user U in a user database (DB) (not shown) of the server 100 in advance.

The server 100 receives the personal information from the second user terminal 300 and registers the user based on the received personal information. Further, the server 100 receives the photographed image showing the view of the user U from the first user terminal 200. Then, the server 100 detects an element of interest included in the view of the user U in the photographed image and generates superimposition information to be displayed in the first user terminal 200 and voice output information to be output from the first user terminal 200 based on the element-related information of the element of interest (which will be described later). Note that personal information may be used for the generation of superimposition information and voice output information. Then, the server 100 transmits the superimposition information and the voice output information to the first user terminal 200.

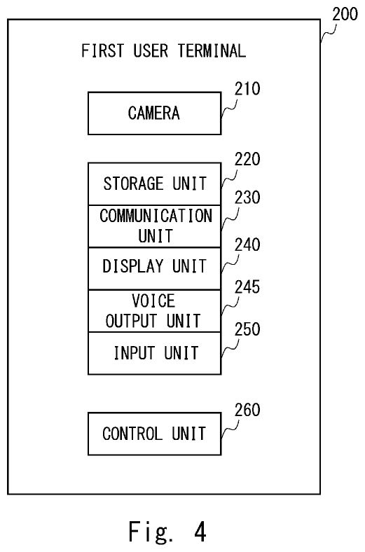

The first user terminal 200 will be described hereinafter in detail. FIG. 4 is a block diagram showing a configuration of the first user terminal 200 according to the second example embodiment. The first user terminal 200 includes a camera 210, a storage unit 220, a communication unit 230, a display unit 240, a voice output unit 245, an input unit 250, and a control unit 260.

The camera 210 is a photographing apparatus that performs photographing according to control by the control unit 260. The camera 210 is provided in the first user terminal 200 so that its view corresponds to (or conforms to) the view of the user U. For example, the camera 210 is disposed in such a manner that when a user U wears the first user terminal 200, the direction of its optical axis coincides with the direction of the line of sight of the user U. The storage unit 220 is a storage device in which a program(s) for implementing the functions of the first user terminal 200 is stored. Further, the storage unit 220 stores a user ID issued from the server 100. The communication unit 230 is a communication interface for communication with the server 100. The display unit 240 is a display device. When the first user terminal 200 is AR glasses or MR glasses, the display unit 240 is disposed on a lens. The voice output unit 245 includes a speaker that outputs voices. The input unit 250 is an input device that receives an input. Note that the input unit 250 is not indispensable in the second example embodiment. The control unit 260 controls hardware of the first user terminal 200.

The control unit 260 controls the camera 210 and photographs a scene (view) visible to the user U. Then, the control unit 260 transmits the photographed image to the server 100 through the communication unit 230. Further, the control unit 260 displays superimposition information received from the server 100 on the display unit 240. Note that in the case where the first user terminal 200 is AR glasses, the view area of the user U corresponds to a photographed image that is obtained by photographing the view of the user U. In this case, the control unit 260 displays, on the display unit 240, an image in which the superimposition information is superimposed on the photographed image. In contrast, when the first user terminal 200 is MR glasses, the view area of the user U is an area in the real space that the user U can see through the lens. In this case, the control unit 260 displays the superimposition information on the display unit 240, which is disposed on the lens, in such a manner that the superimposition information overlaps the aforementioned real space.

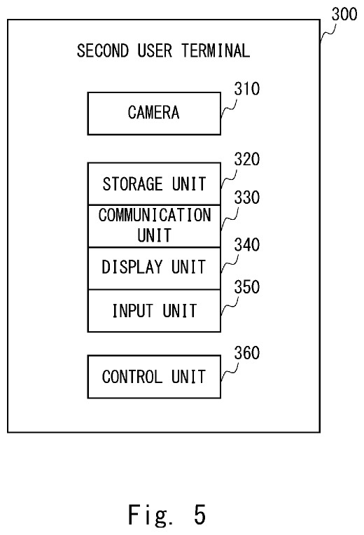

Next, the second user terminal 300 will be described in detail. FIG. 5 is a block diagram showing a configuration of the second user terminal 300 according to the second example embodiment. The second user terminal 300 includes a camera 310, a storage unit 320, a communication unit 330, a display unit 340, an input unit 350, and a control unit 360.

The camera 310 is a photographing apparatus that performs photographing according to control by the control unit 360. Note that the camera 310 is not indispensable in the second example embodiment. The storage unit 320 is a storage device in which a program(s) for implementing the functions of the second user terminal 300 is stored. The communication unit 330 includes a communication interface with the network N. The display unit 340 is a display device. The input unit 350 is an input device that receives an input. The display unit 340 and the input unit 350 may be integrally formed, for example, as a touch panel. The control unit 360 controls hardware of the second user terminal 300.

When a user U is to be registered, the control unit 360 transmits personal information received from the user U through the input unit 350 to the server 100 through the communication unit 330.

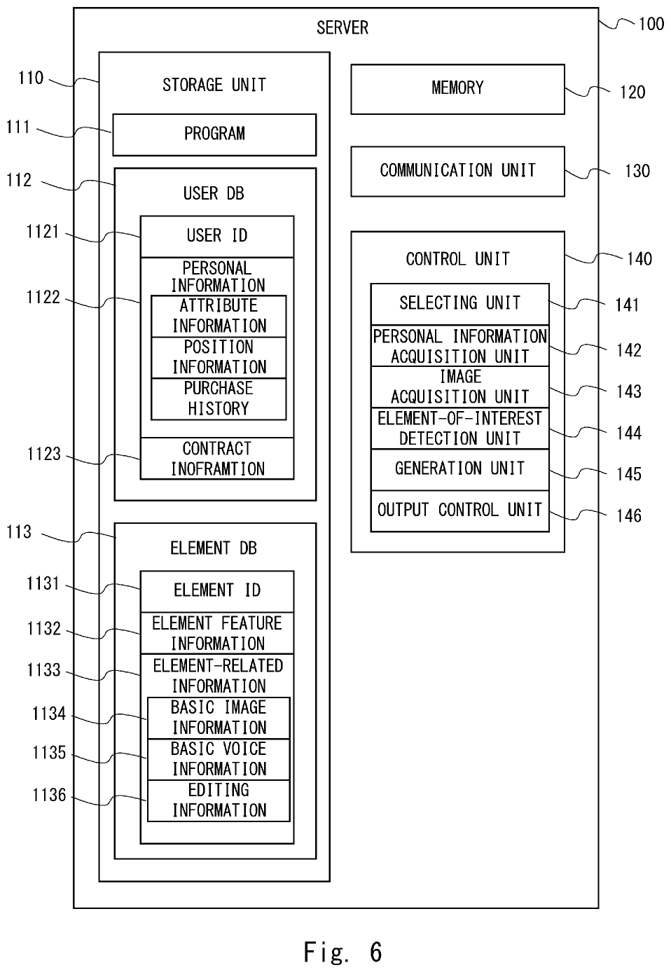

Next, the server 100 will be described in detail. FIG. 6 is a block diagram showing a configuration of the server 100 according to the second example embodiment. The server 100 includes a storage unit 110, a memory 120, a communication unit 130, and a control unit 140.

The storage unit 110 is a storage device such as a hard disk drive or a flash memory. The storage unit 110 stores a program(s) 111, a user DB 112, and an element DB 113. The program 111 is a computer program in which processes performed in the information processing method according to the second example embodiment are implemented.

The user DB 112 is a database storing basic information related to the user U. Specifically, the user DB 112 stores information in which a user ID 1121, personal information 1122, and contract information 1123 are associated with each other. Note that the user ID 1121 is information for identifying the user U.

The personal information 1122 includes at least one of attribute information, position information, a behavior history, a purchase history, and schedule information of the user U. Further, the personal information 1122 may include points that the user U has visited and the numbers of visits. As an example, in this drawing, the personal information 1122 includes attribute information, position information, and a purchase history of the user U. The attribute information may include at least one of an age, an address, a gender, a family structure, contact information, a credit card number, religion information, an inclination attribute, and preference information (taste and preference). The position information is position information of the first user terminal 200 or the second user terminal 300 used by the user U. The schedule information may include an itinerary of the user U.

The contract information 1123 is contract information about a contract between the user U and a service provider.

The element DB 113 is a database storing various types of information related to elements of interest. Specifically, the element DB 113 includes an element ID 1131, element feature information 1132, and element-related information 1133.

The element ID 1131 is information for identifying an element of interest. The element feature information 1132 is information about feature values of the element of interest. The feature values are extracted from an image showing the element of interest.

The element-related information 1133 is information related to the element of interest. The information related to the element of interest is image information for explaining the element of interest and voice information for explaining the element of interest. The image information and the voice information for explaining the element of interest may be image information and voice information indicating a history of the element of interest or a value of the element of interest. Further, the image information for explaining the element of interest may be image information representing a person, an object, a building, or a landscape related to the element of interest, or an avatar of a guide person or the like who explains the element of interest.

The element-related information 1133 includes basic image information 1134, basic voice information 1135, and editing information 1136.

The basic image information 1134 is image information that is used as a basis for superimposition information in a process for generating superimposition information performed by a generation unit 145.

The basic voice information 1135 is voice information that is used as a basis for voice output information in a process for generating voice output information performed by the generation unit 145.

The editing information 1136 is information for editing at least one of the basic image information 1134 and the basic voice information 1135 according to the operating mode. The editing may be adding, deleting, replacing, or converting (modulating).

The memory 120 is a volatile storage device such as a RAM (Random Access Memory) and is a storage area for temporarily holding information when the control unit 140 is operating. The communication unit 130 includes a communication interface for communication with the first user terminal 200 and a communication interface with the network N.

The control unit 140 is a processor, i.e., a control apparatus, that controls each of the components/structures of the server 100. The control unit 140 loads the program 111 from the storage unit 110 onto the memory 120 and executes the loaded program 111. In this way, the control unit 140 implements the functions of a selecting unit 141, a personal information acquisition unit 142, an image acquisition unit 143, an element-of-interest detection unit 144, a generation unit 145, and an output control unit 146.

The selecting unit 141 is an example of the above-described selecting unit 11. When the element-of-interest detection unit 144 detects an element of interest, the selecting unit 141 acquires contract information 1123 associated with its user ID from the user DB 112. Then, the selecting unit 141 selects one of a plurality of operating modes according to the contract information 1123 of the user U. The selecting unit 141 notifies the generation unit 145 of information about the type of the operating mode.

The personal information acquisition unit 142 is also referred to as personal information acquisition means. The personal information acquisition unit 142 receives a user registration request from the second user terminal 300, registers the user, and issues a user ID. In this process, the personal information acquisition unit 142 acquires personal information of the user U from the second user terminal 300. Further, the personal information acquisition unit 142 may acquire personal information of the user U together with his/her user ID at a predetermined timing irrespective of whether it is in the user registration process or not.

An example of a method for acquiring personal information will be shown hereinafter. For example, the personal information acquisition unit 142 acquires attribute information entered by the user U from the second user terminal 300. Further, the personal information acquisition unit 142 acquires position information of the second user terminal 300 at a predetermined timing. Note that the position information may be acquired from the first user terminal 200.

When a behavior history is included in the personal information 1122, the personal information acquisition unit 142 may generate a behavior history based on the history of the position information of the user U. Alternatively, the personal information acquisition unit 142 may acquire schedule information of the user U from the second user terminal 300 and generate a behavior history based on the schedule information. Note that the personal information acquisition unit 142 may acquire schedule information of the user U from a schedule management application that manages the schedule of the user U. Alternatively, the personal information acquisition unit 142 may generate a behavior history from the purchase history of the user U. Note that the personal information acquisition unit 142 may acquire the purchase history of the user U from an application that manages the purchase history.

The personal information acquisition unit 142 registers the personal information acquired from the second user terminal 300 and personal information generated based on information acquired from the second user terminal 300 in the user DB 112 while associating them with the user ID that has been issued as the user has been registered.

Further, when a user is registered or a contract is made, the personal information acquisition unit 142 acquires contract information from the first user terminal 200. The personal information acquisition unit 142 registers the acquired contract information in the user DB 112 in association with the user ID.

The image acquisition unit 143 is an example of the above-described image acquisition unit 13. The image acquisition unit 143 receives and acquires a photographed image from the second user terminal 300.

The element-of-interest detection unit 144 is an example of the above-described element-of-interest detection unit 14. The element-of-interest detection unit 144 determines whether or not an element of interest is detected from a photographed image. Firstly, the element-of-interest detection unit 144 extracts feature values from the photographed image. Note that the element-of-interest detection unit 144 may cut out a predetermined image area from the photographed image and extract feature values of the cut-out image. Then, the element-of-interest detection unit 144 compares the extracted feature values with element feature information 1132 included in the element DB 113, and determines whether or not there is any element feature information 1132 of which a degree of similarity with the extracted feature values is equal to or greater than a predetermined threshold. When there is element feature information 1132 of which the degree of similarity with the extracted feature values is equal to or greater than the predetermined threshold, the element-of-interest detection unit 144 specifies an element ID 1131 corresponding to this element feature information 1132 as an ID of the element of interest.

The generation unit 145 is an example of the above-described generation unit 15. The generation unit 145 acquires element-related information 1133 associated with the specified element ID 1131 in the element DB 113. Further, the generation unit 145 acquires information about the type of the operating mode from the selecting unit 141. Then, the generation unit 145 generates superimposition information based on the acquired element-related information 1133 and the information about the type of the operating mode. Further, the generation unit 145 generates voice output information based on the acquired element-related information 1133 and the information about the type of the operating mode.

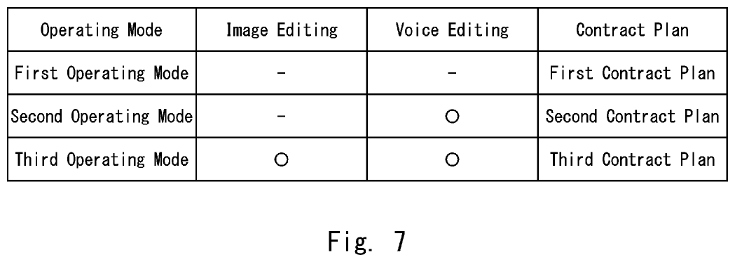

Here, FIG. 7 is a diagram for explaining operating modes according to the second example embodiment. As an example, the operating mode includes a first operating mode, a second operating mode, and a third operating mode. The types of output information that is output by the first user terminal 200 in these operating modes different from each other.

The first operating mode is an operating mode that is used when the contract plan to which the user U subscribes is a first plan. In the first operating mode, the generation unit 145 generates superimposition information without editing the image information and generates voice output information without editing the voice information. That is, the generation unit 145 specifies (i.e., regards) the basic image information 1134 of the element-related information 1133 as superimposition information and specifies (i.e., regards) the basic voice information 1135 of the element-related information 1133 as voice output information.

The second operating mode is an operating mode that is used when the contract plan to which the user U subscribes is a second plan. In the second operating mode, the generation unit 145 generates superimposition information without editing the image information, and generates voice output information by editing the voice information. That is, the generation unit 145 specifies (i.e., regards) the basic image information 1134 of the element-related information 1133 as superimposition information, and generates voice output information by editing the basic voice information 1135 of the element-related information 1133 based on the editing information 1136.

The third operating mode is an operating mode that is used when the contract plan to which the user U subscribes is a third plan. In the third operating mode, the generation unit 145 generates superimposition information by editing the image information, and generates voice output information by editing the voice information. That is, the generation unit 145 generates superimposition information by editing the basic image information 1134 of the element-related information 1133 based on the editing information 1136, and generates voice output information by editing the basic voice information 1135 of the element-related information 1133 based on the editing information 1136.

Note that there may be an operating mode in which the generation unit 145 generates superimposition information by editing image information and generates voice output information without editing voice information. Further, although image information is edited and/or voice information is edited in the first to the third operating modes, the degree of editing or the like may be changed according to the operating mode. For example, the amount of editing and/or the variations of editing may be increased in the order of First operating mode<Second operating mode<Third operating mode.

Note that the editing information 1136 may be fixed editing information defined for each operating mode, or may include a plurality of types of editing information according to the features of the user U. The features of the user U may be, for example, an attribute of the user U or a time during which the user U stays at the place. Further, when the generation unit 145 edits the basic image information 1134 or the basic voice information 1135, it may specify a feature of the user U from the personal information of the user U and perform an editing process by using editing information corresponding to the specified feature of the user U. That is, in at least one of the operating modes, the generation unit 145 may generate superimposition information or voice output information based on the element ID and the personal information.

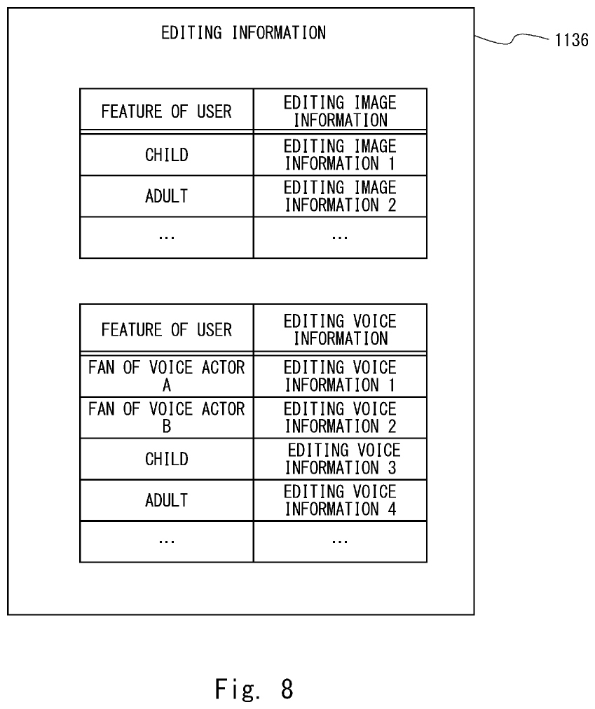

FIG. 8 shows an example of a data structure of editing information 1136 according to the second example embodiment. The editing information 1136 includes information in which a feature of a user U is associated with editing image information. The editing image information is information for editing the basic image information 1134. For example, when the operating mode is the third operating mode, in which the basic image information 1134 is edited, and the user U is a child, the generation unit 145 uses Editing Image Information 1 for generating an image for children. For example, when the operating mode is the third operating mode and the user U is an adult, the generation unit 145 uses Editing Image Information 2 for generating an image for adults.

In this way, the generation unit 145 can determine an expression mode of (i.e., how to express) a person or an object related to the element of interest, or an avatar of a guide person or the like who explains the element of interest based on the personal information, and generate image information based on the determined expression mode. Then, the user U can view an image content that is expected to be desired by the user U according to the operating mode.

Further, the editing information 1136 includes information in which a feature of the user U is associated with editing voice information. The editing voice information is information for editing the basic voice information 1135. For example, when the operating mode is the second or third operating mode, in which the basic voice information 1135 is edited, and the user U is a fan of a voice actor A, the generation unit 145 uses Editing Voice Information 1 for changing the voice to be output to the voice of the voice actor A or modulating the voice to be output to the voice of the voice actor A. Further, for example, when the operating mode is the second or third operating mode and the user U is a child, the generation unit 145 uses Editing Voice Information 3 for converting the wording of the voice to be output to wording for children, changing the voice to be output to a voice for children, or modulating the voice to be output a voice for children.

As a result, the user can listen to a voice content that is expected to be desired by the user U according to the operating mode.

Note that when schedule information including an itinerary of the user U is included in the personal information, the generation unit 145 estimates the stay time of the user U (i.e., the time during which the user U stays) based on the schedule information. Further, in at least one of the operating modes, the generation unit 145 may adjust the running time (i.e., playback time or playback duration) of the content to be provided based on the stay time. For example, the generation unit 145 may determine the playback end time of the superimposition information and the voice output information based on the stay time, and edit the basic image information 1134 and the basic voice information 1135 so that the playback time of the content becomes equal to or shorter than the duration between the scheduled playback start time and the playback end time. As an example, the generation unit 145 may change the playback speed of the basic image information 1134 and the basic voice information 1135, and/or change the amount of information thereof. In this way, the user U can view the content according to his/her schedule. Note that the generation unit 145 may determine the running time (i.e., playback time or playback duration) based on the position information of the user U in addition to or instead of the schedule information and the stay time estimated based thereon. Even in this case, a similar effect is obtained.

Further, when the number of visits of the user U is included in the personal information, the generation unit 145 may edit the content to be provided based on the number of visits in at least one of the operating modes. For example, the generation unit 145 may change the type of editing information for editing the basic image information 1134 and the basic voice information 1135 according to whether the number of visits of the user U is once or twice. In this way, for example, even when the user U visits the place a plurality of times, the server 100 can provide different superimposition information at each visit.

As described above, depending on the operating mode, the processing and editing mode of the image or the voice (i.e., how to process and edit the image or the voice) may be changed according to the feature (e.g., a gender, an age, a hobby, or a schedule) of the user U. In this way, it is possible to configure so that the more upgraded contract plan the operating mode corresponds to or the more heavily-paid contract the operating mode corresponds to, the more the processing and editing are personalized. Therefore, it is possible to improve the satisfaction of the user U and to induce the user U to subscribe to a more upgraded contract plan.

The explanation is continued by referring to FIG. 6 again. The output control unit 146 is an example of the above-described output control unit 16. The output control unit 146 transmits the superimposition information and the voice output information to the first user terminal 200. In this way, the output control unit 146 makes (e.g., instructs) the display unit 240 of the first user terminal 200 display the superimposition information and makes (e.g., instructs) the voice output unit 245 of the first user terminal 200 output the voice output information. Note that the output control unit 146 may transmit information designating the display position of the superimposition information (i.e., the position at which the superimposition information is displayed) to the first user terminal 200 in such a manner that the superimposition information overlaps the detected element of interest or is positioned in the vicinity of the element of interest in the view area of the user U.

Note that the output control unit 146 may have a function of outputting (e.g., displaying) means for entering personal information and contract information to the second user terminal 300.

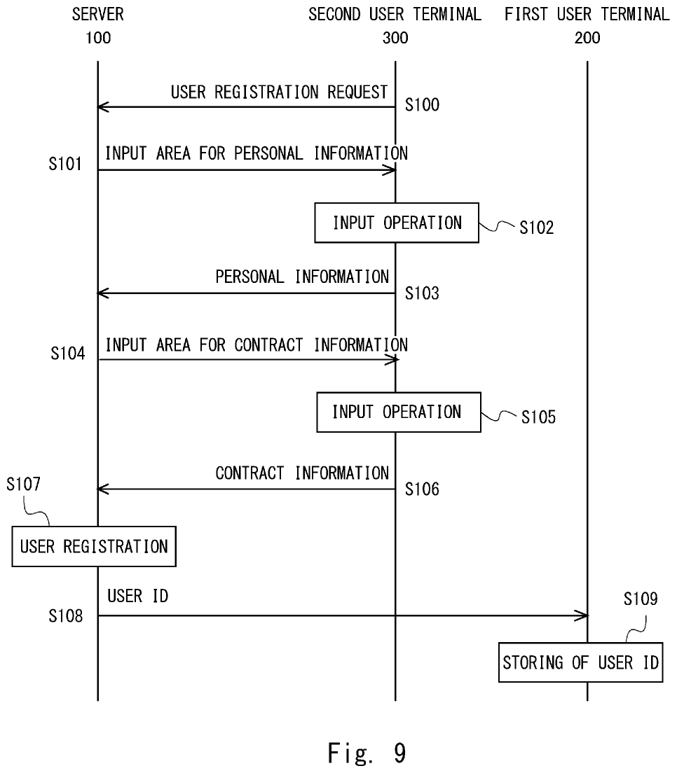

FIG. 9 is a sequence diagram showing a flow of a user registration process according to the second example embodiment. Firstly, the second user terminal 300 transmits a user registration request to the server 100 (S100). The output control unit 146 of the server 100 transmits an input area (also referred to as an input screen) for personal information to the second user terminal 300, and makes (e.g., instructs) the second user terminal 300 display the transmitted input area (S101). Alternatively, the output control unit 146 of the server 100 may make (e.g., instruct) the second user terminal 300 output (e.g., display) means for inputting a voice for personal information. Here, the user U performs an operation for entering personal information by using the input unit 350 of the second user terminal 300 (S102). Upon receiving the input operation, the second user terminal 300 transmits the input personal information to the server 100 (S103). As a result, the personal information acquisition unit 142 of the server 100 receives the personal information entered in the input area from the second user terminal 300. Further, the output control unit 146 of the server 100 makes (e.g., instructs) the second user terminal 300 also output (e.g., display) means for entering contract information as well as for the personal information, and acquires contract information from the second user terminal 300 (S104, S105, S106).

The personal information acquisition unit 142 of the server 100, which has received the personal information and the contract information, issues a user ID, associates the user ID with the personal information and the contract information, and registers them in the user DB 112 (S107). Then, the personal information acquisition unit 142 of the server 100 notifies the first user terminal 200 of the user ID (S108). Then, the first user terminal 200 stores the user ID in the storage unit 220 (S109). Note that the personal information acquisition unit 142 of the server 100 may, instead of performing the step S108, notify the second user terminal 300 of the user ID. In this case, the user U may input the user ID to the input unit 250 of the first user terminal 200 and store the user ID in the storage unit 220.

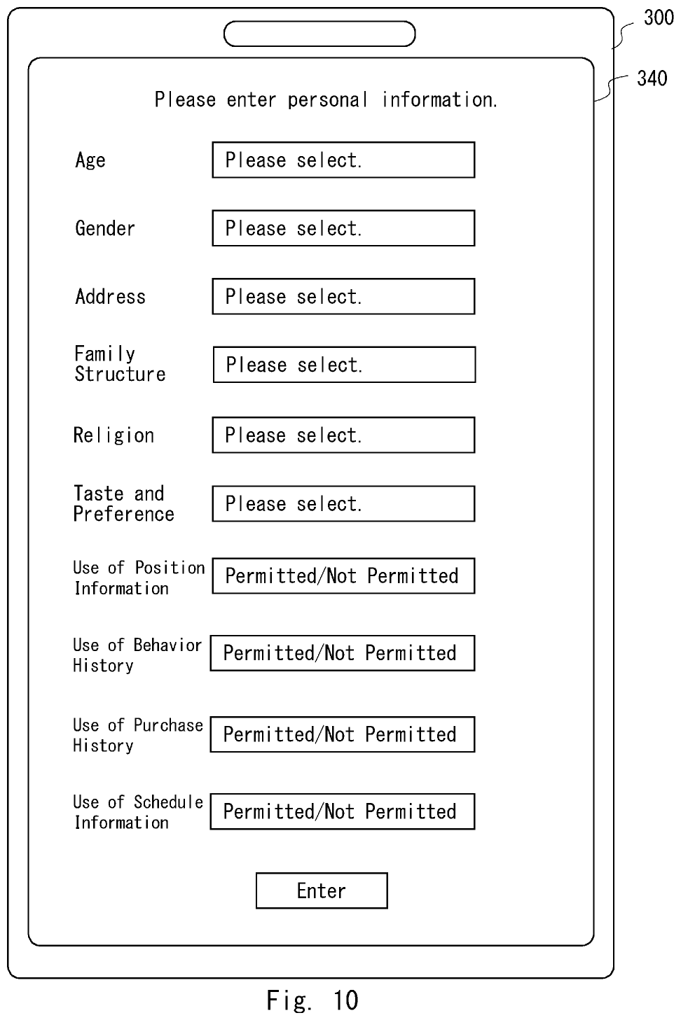

FIG. 10 shows an example of an input screen for personal information displayed in the second user terminal 300 according to the second example embodiment. In the step S102 in FIG. 9, an input area for personal information necessary for user registration is displayed on the display unit 340 of the second user terminal 300. For example, areas for entering attribute information, whether or not the use of position information of the second user terminal 300 is permitted, whether or not the use of a behavior history is permitted, whether or not the use of a purchase history is permitted, and whether or not the use of schedule information is permitted are displayed on the display unit 340. In this drawing, as the input area for attribute information, input areas for an age, a gender, an address, a family structure, a religion, and taste and preference are shown. Further, an input area for “Enter” is displayed on the display unit 340. In response to the selection of this input area by the user U, the second user terminal 300 transmits the input personal information of the user U to the server 100 in the step S103.

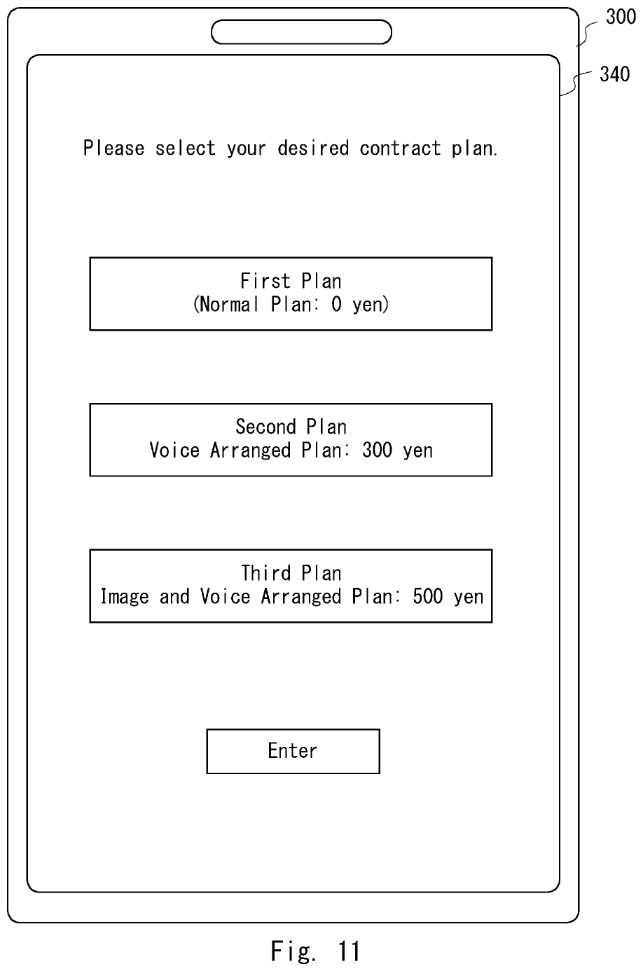

FIG. 11 shows an example of an input screen for contract information displayed in the second user terminal 300 according to the second example embodiment. In the step S105 in FIG. 9, an input area for contract information is displayed on the display unit 340 of the second user terminal 300. The contract information is, for example, the type of a contract plan. As an example, the user U selects one of first to third plans for which he/she wants to make a contract. The first plan may be a normal contract plan under which basic image information and basic voice information are provided. The second plan may be a contract plan under which arranged voice information, in addition to the normal image information, is provided. The third plan may be a contract plan under which arranged image information and arranged voice information are provided. The prices set for the first to third plans may be different from one another. For example, the first plan may be used for free, and there may be charges for the second and third plans. The usage fee of the third plan under which information or the like is more arranged may be higher than that of the second plan. Note that the plans are not limited to the first to the third plans. That is, there may be a contract plan of which the usage fee is higher than that of the third plan, and under which the image and voice are more processed and edited according to the feature (e.g., a gender, an age, a hobby, or an itinerary) of the user U than under the third plan. By adopting such a configuration, it is possible to configure so that the more upgraded contract plan the operating mode corresponds to or the more heavily-paid contract the operating mode corresponds to, the more the processing and editing are personalized. Therefore, it is possible to improve the satisfaction of the user U and to induce the user U to subscribe to a more upgraded contract plan.

Further, an input area for “Enter” is displayed on the display unit 340. In response to the selection of this input area by the user U, the second user terminal 300 transmits the selected contract information to the server 100 in the step S106. Then, the server 100 may proceed with a contract process, and upon the completion of the contract process, perform a process shown in the step S107. Alternatively, the user U may designate the already-contracted contract plan in the above-described input screen. In this case, the server 100 performs the process shown in the step S107 in response to the acquisition of information about the contract made in the step S106.

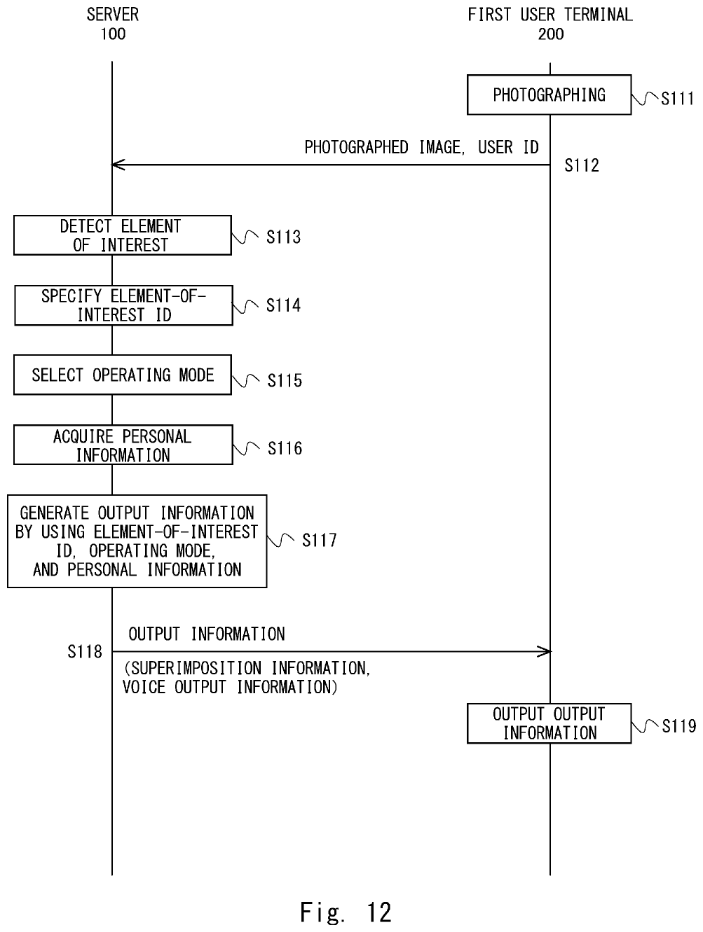

FIG. 12 is a sequence diagram showing a flow of an output process according to the second example embodiment. Firstly, the first user terminal 200 photographs the view of the user U (S111), and transmits the photographed image to the server 100 together with a user ID (S112). As a result, the image acquisition unit 143 of the server 100 acquires the photographed image and the user ID.

Next, the element-of-interest detection unit 144 of the server 100 detects an element of interest in the photographed image (S113), extracts feature values of the element of interest, and specifies an element ID of the element of interest based on the extracted feature values by using the element DB 113 (S114). The element-of-interest detection unit 144 supplies the specified element ID to the generation unit 145. Further, the selecting unit 141 acquires contract information 1123 associated with the acquired user ID by using the user DB 112, and selects an operating mode based on the contract information 1123 (S115). The selecting unit 141 supplies the type of the selected operating mode to the generation unit 145.

Next, the generation unit 145 acquires personal information associated with the acquired user ID by using the user DB 112 (S116). Next, the generation unit 145 generates output information based on the element ID and the operating mode by using the element DB 113 (S117). In this process, the generation unit 145 generates the output information by also using personal information according to the type of the operating mode. The following are a specific generation process performed by the generation unit 145. Firstly, the generation unit 145 acquires element-related information 1133 associated with the specified element ID from the element DB 113. Further, the generation unit 145 infers a feature(s) of the user U from the personal information. Further, the generation unit 145 determines whether or not the basic image information 1134 and the basic voice information 1135 included in the element-related information 1133 need to be edited, and the type of information to be edited (whether the information to be edited is the basic image information 1134 or the basic voice information 1135) based on the operating mode.

Then, when no editing is necessary, the generation unit 145 specifies (generates) the basic image information 1134 and the basic voice information 1135 themselves as output information.

On the other hand, when editing is necessary, the generation unit 145 specifies, among pieces of editing information 1136 included in the element-related information 1133, a piece(s) of editing information which corresponds to the type of information to be edited and is associated with the inferred feature of the user U. Then, the generation unit 145 generates output information by editing the basic information by using the specified editing information. For example, in the second operating mode, the generation unit 145 generates voice output information by editing the basic voice information 1135 by using the editing voice information of the editing information 1136. Then, the generation unit 145 defines (or regards) the basic image information 1134 as superimposition information and generates output information in which the superimposition information is associated with the voice output information. Further, in the third operating mode, the generation unit 145 generates superimposition information by editing the basic image information 1134 by using the image editing information of the editing information 1136, and generates voice output information by editing the basic voice information 1135 by using the voice editing information. Then, the generation unit 145 generates output information in which the superimposition information is associated with the voice output information.

Then, the output control unit 146 transmits the output information to the first user terminal 200 (S118). Upon receiving the output information, the first user terminal 200 displays the superimposition information included in the output information on the display unit 240 and outputs the voice output information included in the output information to the voice output unit 245 (S119).

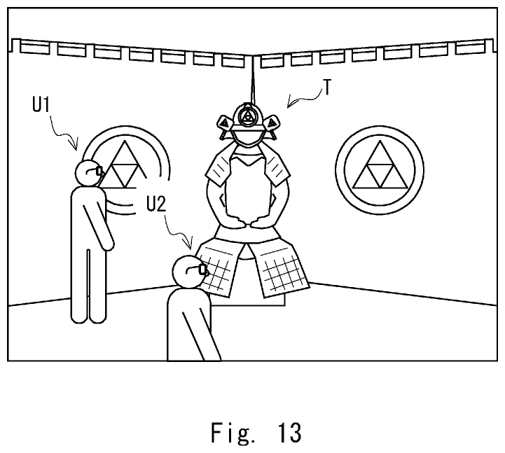

FIG. 13 shows an example of a case where an element of interest T is present in the fields of view of a plurality of users. The element of interest T is a suit of armor (hereinafter also referred to simply as an armor) displayed as an exhibit in a history museum. A plurality of users U1 and U2 are looking at the same element of interest T through their respective first user terminals 200.

For example, the user U1 is an adult and the user U2 is a child. It is assumed that the users U1 and U2 both subscribe to the third plan.

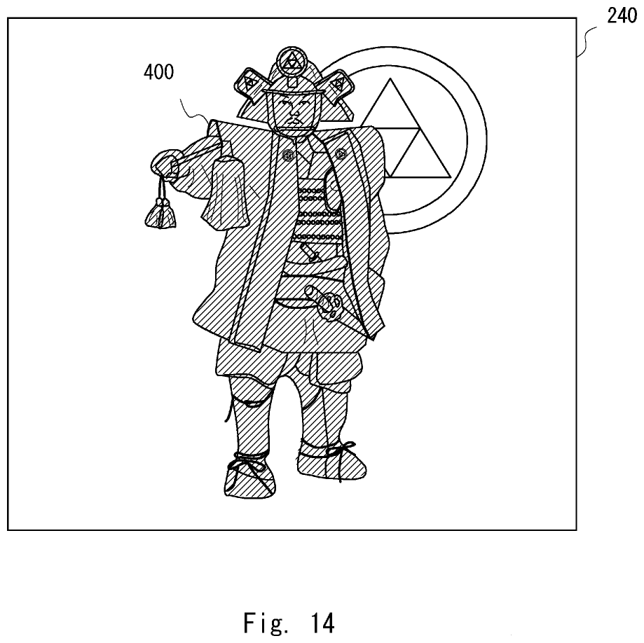

FIG. 14 shows an example of superimposition information displayed on the first user terminal 200 of the user U1 according to the second example embodiment. A hatched area shown in this drawing indicates a superimposition image 400 displayed on the display unit 240 of the first user terminal 200 of the user U1. The superimposition image 400 shows an avatar of a historical person who used the armor, which is the element of interest T. The avatar shown in the superimposition image 400 is one that is obtained by editing the basic image information using editing image information associated with an “adult” so as to match the feature “adult” inferred from the personal information of the user U1. Note that while the superimposition image 400 is displayed, the voice output unit 245 of the first user terminal 200 outputs voice output information for explaining the element of interest T in conjunction with the superimposition image 400. This voice output information may be one that is obtained by editing the basic voice information using editing voice information associated with an “adult” so that its wording or voice becomes one that matches the feature “adult” inferred from the personal information of the user U1.

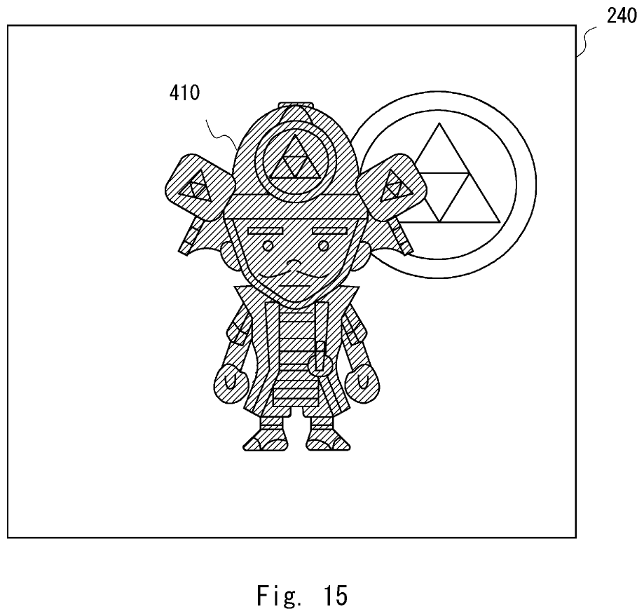

FIG. 15 shows an example of superimposition information displayed on the first user terminal 200 of the user U2 according to the second example embodiment. A hatched area shown in this drawing indicates a superimposition image 410 displayed on the display unit 240 of the first user terminal 200 of the user U2. The superimposition image 410 shows an avatar of an animated-cartoon character who used the armor, which is the element of interest T. The avatar shown in the superimposition image 410 is one that is obtained by editing the basic image information using editing image information associated with a “child” so as to match the feature “child” inferred from the personal information of the user U2. Note that while the superimposition image 410 is displayed, the voice output unit 245 of the first user terminal 200 outputs voice output information in conjunction with the superimposition image 410. This voice output information may be one that is obtained by editing the basic voice information using editing voice information associated with a “child” so that its wording or voice becomes one that matches the feature “child” inferred from the personal information of the user U2.

Note that in the case where the user U2 is an animated-cartoon lover or a drama lover, the avatar shown in the superimposition image 410 may be an avatar of a character of an animated cartoon of which the story unfolds in the place where the element of interest T is displayed, or an avatar of an actor who appears in a drama of which the story unfolds in the place where the element of interest T is displayed. Further, the voice output information may be the voice of a voice actor of a character of an animated cartoon or the voice of an actor thereof, or a voice similar to the voice of the voice actor or the voice of the actor thereof.

As described above, the superimposition information related to the element of interest T may include image information representing a person related to the element of interest T or an avatar of a guide person or the like who explains the element of interest T, and may be one that is edited in such a manner that the element of interest T is expressed in a form or the like suitable to the preference of the user. Further, the superimposition information related to the element of interest T is not limited to the above-described example, and may include image information representing an object, a building, or a landscape related to the element of interest T.

Note that the superimposition information related to the element of interest T may be one that dramatize the space where the element of interest T is present.

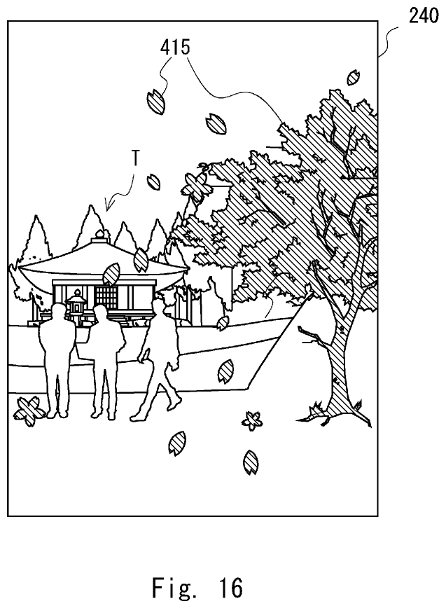

FIG. 16 shows an example of superimposition information displayed in the first user terminal 200 according to the second example embodiment. For example, the element of interest T is a landscape or a building, and a superimposition image 415 is displayed on the display unit 240 of the first user terminal 200 when the user U sees the element of interest T through the first user terminal 200. The superimposition image 415 is an image for dramatizing the space where the element of interest T is present, and it is an image of a cherry tree and petals for expressing the “spring” in this drawing.

Note that the server 100 may dramatize the space or the like in a different manner according to the operating mode corresponding to the contract plan. For example, the server 100 may not include (i.e., not incorporate) the above-described image for expressing the “spring” in the superimposition information provided to a user U who has contracted the first plan. In contrast, the server 100 may include (i.e., incorporate) the above-described image for expressing the “spring” in the superimposition information provided to a user U who has contracted the second or third plan. In this way, it is possible to induce the user U to update (e.g., upgrade) the contract plan.

As described above, according to the second example embodiment, when the server 100 provides information related to an element of interest T that has come into the view of a user U to the user U, it changes the information provided to the user U according to the operating mode. The operating mode may be determined according to the type or the like of the contract. In this way, the server 100 can change the amount of information, the quality of information, or how to provide information according to the contract plan or the money-paying situation of the user U. For example, the server 100 may provide an image and a voice to a user U in such a manner that the more upgraded contract plan the operating mode corresponds to or the more heavily-paid contract the operating mode corresponds to, the more satisfactorily the image and the voice are edited in a personalized manner according to the feature of the user U. In this way, it is possible provide information to the user U in such a manner that the more upgraded the contract plan is or the more the money is paid, the more satisfactory the information provided to the user U becomes. Therefore, it is possible to induce the user U to subscribe to a more upgraded contract plan.

### Third Example Embodiment

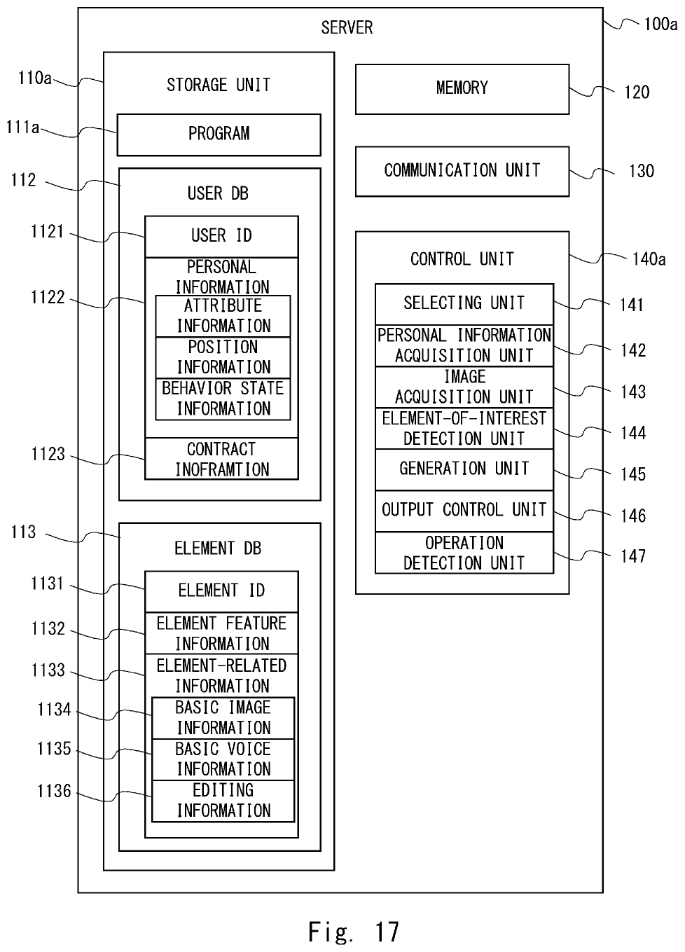

Next, a third example embodiment according to the present disclosure will be described. The third example embodiment is characterized in that a server detects an operation performed by a user and performs an operating mode change process according to the type or the like of the operation. FIG. 17 is a block diagram showing a configuration of a server 100a according to the third example embodiment. The server 100a includes a storage unit 110a and a control unit 140a in place of the storage unit 110 and the control unit 140. The storage unit 110a stores a program 111a instead of the program 111. The program 111a is a computer program in which processes performed in an information processing method according to the third example embodiment are implemented.

The control unit 140a includes an operation detection unit 147 in addition to the components of the control unit 140. The operation detection unit 147 is also referred to as operation detection means. The operation detection unit 147 detects a selecting operation performed by a user U. Note that in the third example embodiment, the output control unit 146 makes (e.g., instructs) the first user terminal 200 display a selection receiving image at a predetermined timing in such a manner that the selection receiving image overlaps the view area. The selection receiving image is an image for changing the operating mode. When the operating mode is changed to a higher (or upgraded) operating mode, the selection receiving image may be referred to as an add-on button. The higher (or upgraded) operating mode may be an operating mode corresponding to an upgraded contract plan or an operating mode in which an amount of editing is large. Further, the selection receiving image may be an operating mode that the server 100a recommends to the user U based on the personal information of the user U. It is assumed that the selection receiving image is displayed on the display unit 240 of the first user terminal 200, and the image acquisition unit 143 of the server 100a has acquired a photographed image showing the view of the user U while the selection receiving image is being displayed. In this case, the operation detection unit 147 detects an operation for selecting the selection receiving image performed by the user U based on the position of a hand of the user U in the photographed image and the superimposition position of the selection receiving image in the view area (i.e., the display position of the selection receiving image in the display unit 240).

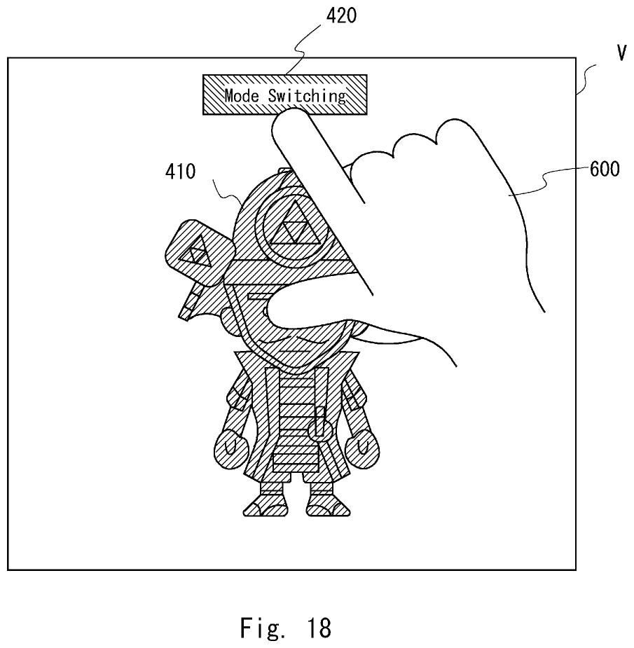

FIG. 18 is a diagram for explaining a process for detecting a selecting operation according to the third example embodiment. In this drawing, a photographed image V of the view of a user U when a selection receiving image 420 is displayed is shown. Note that an image area showing the hand of the user U (i.e., a hand area 600) is included in the photographed image V. Note that although the selection receiving image 420 is shown in this drawing for the sake of convenience, the selection receiving image 420 do not necessarily have to be included in the photographed image V.

The operation detection unit 147 first detects the hand area 600 in the photographed image V, and then detects a fingertip from the hand area 600. Then, the operation detection unit 147 determines whether or not the position of the fingertip corresponds to the display position of the selection receiving image 420. In this drawing, the operation detection unit 147 determines that the position of the fingertip corresponds to the display position of the selection receiving image 420. Therefore, the operation detection unit 147 determines that the selection receiving image 420 is pressed (selected) by the user U. Note that in order to avoid the detection of a false operation, the operation detection unit 147 may detect a selecting operation performed by the user U only when it determines that, in addition to the detection of the state in which the position of the fingertip corresponds to the display position of the selection receiving image 420, a predetermined operation(s) has been performed before or/and after this state. The predetermined operation may be, for example, placing the fingertip at the position corresponding to the display position of the selection receiving image 420 for a predetermined time, or may be a clicking operation is performed by the finger.

Then, the selecting unit 141 changes the operating mode in response to the detection of the selecting operation of the selection receiving image 420. For example, the selecting unit 141 may change the operating mode to a higher (or upgraded) operating mode. Further, when a plurality of selection receiving images are displayed according to the operating mode, the selecting unit 141 may change the operating mode to one that corresponds to the selected selection receiving image. Further, in response to the detection of the selecting operation, the selecting unit 141 may proceed with a contract process, update (or renew) the contract information, and then change the operating mode. In the contract process and the updating of the contract information, the selecting unit 141 may perform them in such a manner that the higher the grade of the contract plan selected by the user U is (the more upgraded the contract plan is), the more the money is paid.

Further, by using the detection of an operation for selecting an operating mode as a trigger, the selecting unit 141 may change the operating mode to one corresponding to the upgraded contract plan only for a predetermined time (e.g., only for tens of seconds), i.e., as a trial period, without updating the contract information. During this trial period, the output control unit 146 may make (e.g., instruct) the first user terminal 200 display the price of the use of the upgraded contract plan and a selection receiving image for selecting whether or not to update (e.g., renew) the contract information. Then, when the selecting unit 141 detects an operation for selecting a selection receiving image indicating that the user or the like intends to update (e.g., renew) the contract information, it may proceed with a contract process, update the contract information, and then maintain the changed operating mode. On the other hand, when the selecting unit 141 detects an operation for selecting a selection receiving image indicating that the user or the like intends not to update (e.g., renew) the contract information, it may return the changed operating mode to the original operating mode (i.e., the operating mode before being temporarily changed).

In response to the change of the operating mode, the generation unit 145 generates superimposition information and voice output information according to the operating mode in a manner similar to that in the second example embodiment. Then, the output control unit 146 makes (e.g., instructs) the first user terminal 200 display the changed superimposition information so that the changed superimposition information overlaps the view area of the user U. Further, the output control unit 146 makes (e.g., instructs) first user terminal 200 output the changed voice output information.

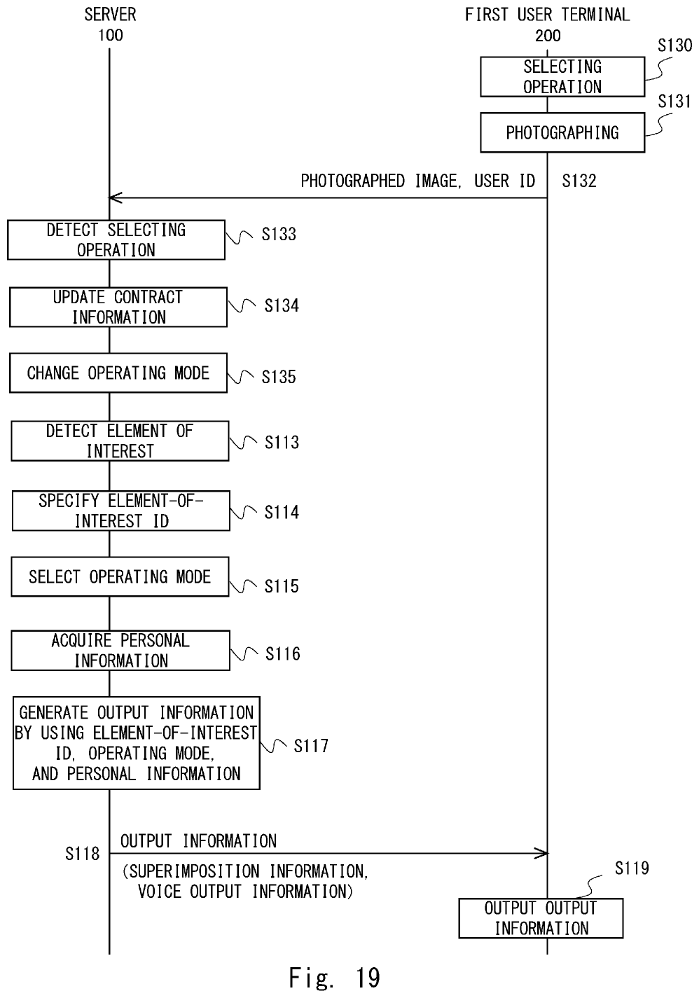

FIG. 19 is a sequence diagram showing a flow of an output process according to the third example embodiment. The steps shown in FIG. 19 include steps S130 to S135 in place of the steps S111 to S112 shown in FIG. 12.

Firstly, a user U performs an operation for selecting an operating mode, such as clicking a selection receiving image (S130). The first user terminal 200 photographs the view of the user U (S131) and transmits the photographed image to the server 100 together with a user ID (S132). As a result, the image acquisition unit 143 of the server 100 acquires the photographed image and the user ID.

The operation detection unit 147 of the server 100a detects a selecting operation in the photographed image (S133). In response to the detection of the selecting operation, the selecting unit 141 updates (i.e., renews) contract information associated with the user ID of the user DB 112 (S134). Then, the selecting unit 141 changes the operating mode in response to the updating of the contract information (S135). Note that steps S113 to S119 are similar to those in FIG. 12.

As described above, according to the third example embodiment, the server 100a detects a selecting operation performed by the user U based on the position of a hand of the user U in the photographed image and the display position of the selection receiving image, and performs an operating mode change process corresponding to the detected selecting operation. In this way, in addition to the registration in advance, it is possible to change/update the contract plan when the user U is obtaining a service in real time. By changing the contents of information provided to the user U in such a manner that the more the user U pays money or the more upgraded contract plan the user subscribes to, the more personalized and more satisfactory the information or the like provided to the user U becomes. By doing so, it is possible to induce the user U to pay more money or subscribe to an upgraded contract plan. Note that by enabling the user U to easily pay money or change the contract plan in a touchless manner when he/she is using the first user terminal 200, it is possible to induce the user U to pay money or subscribe to an upgraded contract plan even further.

Note that the contract plans may include various plans that are different from one another according to the taste and preference. Further, the server 100a may propose a plurality of (two or three) candidate contract plans to the user U according to the personal information (taste/preference) of the user U. For example, the server 100a may induce a contract plan for animated-cartoon fans to a user U who likes animated cartoons, a contract plan for baseball fans to a user U who likes baseball, and a contract plan for travel fans to a user U who likes travelling. In this case, the server 100a may make (e.g., instruct) the first user terminal 200 display, as the selection receiving image, candidate contract plans.

### Fourth Example Embodiment

Next, a fourth example embodiment according to the present disclosure will be described. A server 100a according to the fourth example embodiment has, basically, a configuration and functions similar to those of the server 100a according to the third example embodiment, and therefore descriptions of them are omitted. However, the fourth example embodiment is characterized in that the operating mode includes an operating mode in which information based on an interactive process is provided.

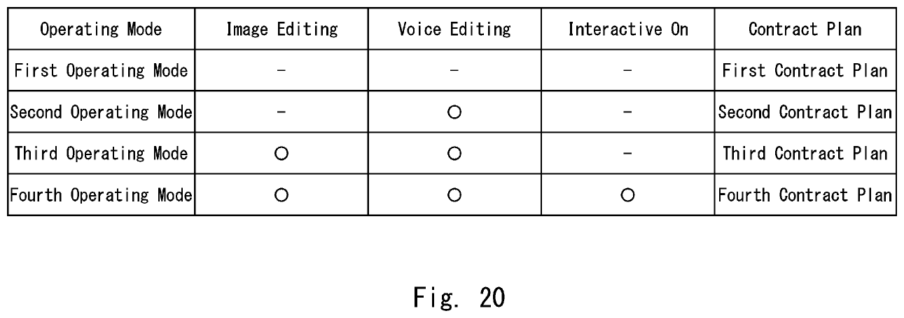

FIG. 20 is a diagram for explaining operating modes according to the fourth example embodiment. In the fourth operating mode shown in this drawing, the first user terminal 200 is made to output (i.e., display and output voices for) information that is generated based on an interactive process (hereinafter also referred to as interactive-process-based information) to the first user terminal 200. The interactive process is a process for generating interactive information according to the reaction of a user U. Note that the reaction may be a psychological state or a conversation content. For example, the image acquisition unit 143 of the server 100a acquires, from the first user terminal 200, at least one of a photographed image obtained by photographing the face of the user U and a voice uttered by the user U. The generation unit 145 infers the reaction of the user U based on the acquired information and generates image information and voice information according to the inferred reaction. Note that the generation unit 145 may edit, by using the image information and the voice information according to the reaction as the basis, the image information and the voice information by using editing information that is generated according to the personal information. In this way, the generation unit 145 generates interactive output information.

Note that in the first to the third operating modes shown in this drawing, information that is generated based on a non-interactive process (hereinafter also referred to as non-interactive-process-based information) may be output to the first user terminal 200. For example, in the first operating mode, predetermined basic image information and predetermined basic voice information are output as they are (i.e., without editing them). Further, in the second operating mode, predetermined basic image information and information obtained by editing predetermined basic voice information using editing information corresponding to personal information are output. Further, in the third operating mode, information obtained by editing predetermined basic image information using editing image information corresponding to personal information and information obtained by editing predetermined basic voice information using editing voice information corresponding to personal information are output.

Although interactive-process-based information is output only in the fourth operating mode in this drawing, the present disclosure is not limited to this example. That is, there may be a plurality of operating modes in each of which interactive-process-based information is output. For example, how much (i.e., how long or how often) the user U can interact with the avatar may be changed from one operating mode to another, and these operating modes are determined according to the amount of money the user U has paid or the contract plan the user U subscribes to. Further, the degree of popularity of the character that appears as the avatar may be changed from one operating mode to another, and these operating modes are determined according to the amount of money the user U has paid or the contract plan the user U subscribes to.

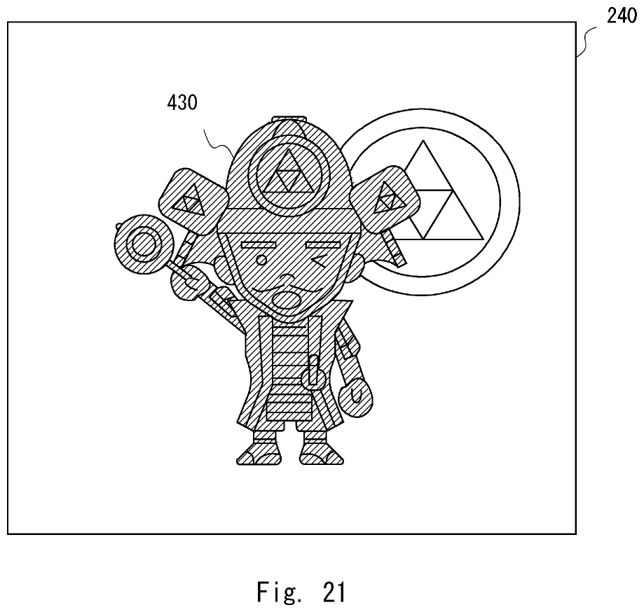

FIG. 21 shows an example of superimposition information displayed on the first user terminal 200 according to the fourth example embodiment. For example, in the fourth operating mode, an avatar who interacts with the user U may be displayed as a superimposition image 430 on the display unit 240. The generation unit 145 of the server 100a may change the facial expression of the avatar, change its movements (e.g., behaviors), or change its speech according to the reaction of the user U. The change of the speech of the avatar may include a change in the content of its speech in addition to a change in the wording of its speech. When the content of the speech of the avatar is changed, for example, the generation unit 145 may specify a topic that the user U is likely to have an interest based on the content of the speech made by the user U, his/her facial expression, his/her response (reaction or reply) and the like, and use the specified topic at the center of the content of the speech of the avatar. Further, the generation unit 145 may exclude a topic that the user U is unlikely to have an interest from the content of the speech of the avatar. As described above, in the fourth operating mode, it is possible to provide a superimposition image and a voice that are changed according to the content of the interaction with the user U, thus enabling the user U to interact with the avatar. Therefore, it is possible to improve the satisfaction of the user U even further. Meanwhile, the user U cannot interact with the avatar in the first to third operating modes. Therefore, it is possible to induce the user U to subscribe to the fourth plan which corresponds to the fourth operating mode and of which the usage fee is high.

As described above, in the fourth example embodiment, the output information in the operating mode includes at least one of superimposition information and voice output information of non-interactive-process-based information, and superimposition information and voice output information of interactive-process-based information. By increasing the variations of the output information, it is possible to effectively induce the user U to subscribe to an upgraded contract plan or to pay money.

### Fifth Example Embodiment

Next, a fifth example embodiment according to the present disclosure will be described. The fifth example embodiment is characterized in that a server 100a uses personal information of a companion of a user U (e.g., a person who is traveling with a user U) when it provides information to the user U. The server 100a according to the fifth example embodiment has, basically, a configuration and functions similar to those of the server 100a according to the fourth example embodiment. However, in the fifth example embodiment, the second user terminal 300 of the user U transmits personal information of a companion of the user U to the server 100a in addition to or instead of the personal information of the user U. For example, an area for entering personal information of a companion may be included in the input screen for personal information shown in FIG. 10.

The personal information acquisition unit 142 of the server 100a acquires personal information of the user U and personal information of his/her companion from the second user terminal 300 of the user U. Then, the generation unit 145 generates output information (superimposition information and voice output information) based on the element ID of the element of interest, the personal information of the user U, and the personal information of the companion. In this way, the server 100a can provide information in which not only the personal information of the user U himself/herself but also the personal information, such as taste and preferences, of the companion is taken into consideration.

Further, the personal information acquisition unit 142 may acquire, from the second user terminal 300, information about the degree of importance of the personal information of the companion relative to that of the personal information of the user U in addition to the personal information of the user U and the personal information of the companion.

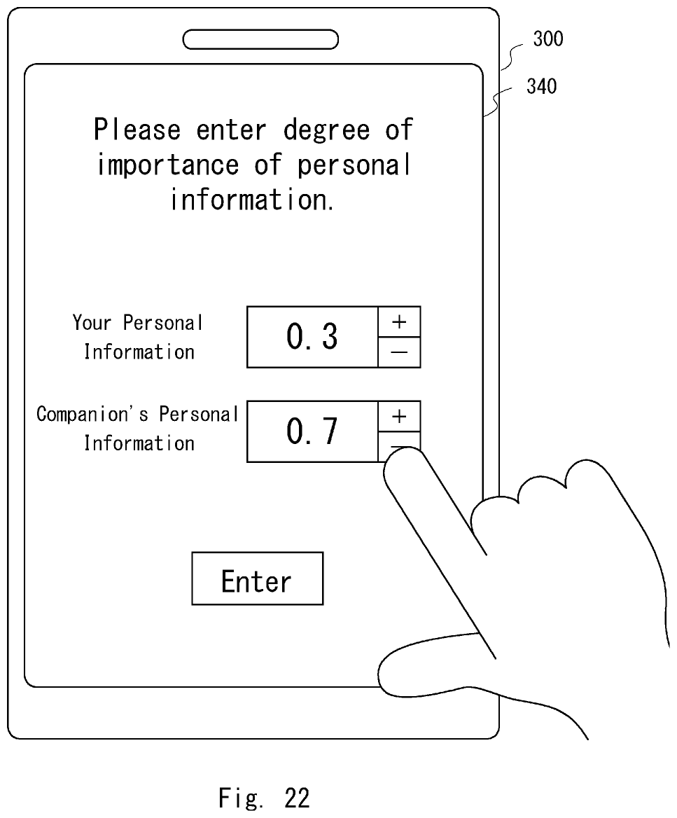

Note that the output control unit 146 of the server 100a makes (i.e., instructs) the second user terminal 300 display an input screen for the degree of importance in the step S101 shown in FIG. 9. FIG. 22 shows an example of an input screen for the degree of importance of personal information displayed in the second user terminal 300 according to the fifth example embodiment.

As shown in FIG. 22, on the display unit 340, an input area for the degree of importance of the personal information of the user U and an input area for the degree of importance of the personal information of the companion are displayed. In this input screen, the value of each of the degrees of importance can be changed in response to an adding operation or a subtracting operation performed by the user U. Note that in this input screen, the ratio of the degree of importance of personal information of the user U and that of the degree of importance of personal information of the companion may be adjusted so that the total of these ratios becomes one. When there are a plurality of companions, the ratio of the degree of importance of personal information of the user U and the ratios of the degrees of importance of personal information of the companions may be adjusted so that the total of these ratios becomes one. Alternatively, these adjustments may be made by the personal information acquisition unit 142 of the server 100a. Further, an input area for “Enter” is displayed on the display unit 340. When the user U selects these input areas, the second user terminal 300 transmits the degree of importance of personal information of the user U and that of the companion to the server 100a, which have been input in the input areas, together with the user ID.

Note that the input screen for the degree of importance may be displayed not only on the display unit 340 of the second user terminal 300 but also on the display unit 240 of the first user terminal 200. In this case, the server 100a may include an operation detection unit 147. When the user U performs a predetermined operation in the real space in response to the display of an input screen for the degree of importance on the display unit 240, the operation detection unit 147 may detect an input operation in the photographed image and perform a process according to the input operation.

When the personal information acquisition unit 142 acquires the personal information of the companion and information about the degree of importance, the generation unit 145 generates superimposition information based on the personal information of the user U, the personal information of the companion, and the degree of importance. For example, the generation unit 145 first generates personal information as that for a group from the personal information of the user U and the personal information of the companion which has been weighted by the degree of importance. Then, the generation unit 145 generates superimposition information based on element-related information associated with the element ID and the personal information as that for the group. Further, the generation unit 145 may generate voice output information based on the element-related information associated with the element ID and the personal information as that for the group. The method for generating superimposition information and voice output information may be similar to the method described in the above-described first to fourth example embodiments, but the term “personal information of the user U” in the descriptions may be replaced with the “personal information as that for the group”.

As described above, according to the fifth example embodiment, the server 100a can generate output information based on personal information weighted by the degree of importance between the personal information of the user U and that of the companion. Therefore, it is possible to provide, to the user U, information that reflects the intention of the group more appropriately.

Note that each of the user U and the companion of the user U carries a first user terminal 200 or has a first user terminal 200 attached to him/her, and may see an element of interest through the first user terminal 200. The same superimposition information may be displayed on each of the first user terminals 200, and the same voice output information may be output therefrom. In this way, the user U and the companion of the user U can experience the same video images and the like.

Note that the above-described example embodiments have been described as hardware configurations, but the present disclosure is not limited to the hardware configurations. The present disclosure may also be implemented by causing a CPU to execute a computer program.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the present disclosure is not limited to the above-described example embodiments, and they may be modified as appropriate without departing from the scope and spirit of the disclosure. For example, in the above-described example embodiments, the first user terminal 200 outputs both the superimposition information and the voice output information generated by the server 100 or 100a and thereby provides them to the user U. However, the second user terminal 300 may instead output one or both of the superimposition information and the voice output information. For example, the first user terminal 200 may output the superimposition information and the second user terminal 300 may output the voice output information.

Further, for example, the first user terminal 200 is connected to the second user terminal 300 through a wire or wirelessly, and transmission and reception of information between the server 100 or 100a and the second user terminal 300 may be performed through the second user terminal 300 connected to the network N. As an example, the first user terminal 200 may communicate with the second user terminal 300 by short-range radio communication such as Bluetooth (Registered Trademark). The first user terminal 200 photographs the view of the user U and transmits the photographed image to the server 100 or 100a through the second user terminal 300. In this process, the second user terminal 300 may attach a user ID to the photographed image and then transmit the photographed image to the server 100 or 100a. Further, the first user terminal 200 superimposes superimposition information received from the server 100 or 100a through the second user terminal 300 on the view area of the user U and displays it in a superimposed manner. Further, the first user terminal 200 outputs the voice output information received from the server 100 or 100a through the second user terminal 300 by the voice output unit 245. Further, the server 100 or 100a may acquire personal information by displaying an input screen for personal information on the first user terminal 200 and detecting an operation for entering personal information based on a photographed image in which the user U has performed a predetermined operation. Further, the information processing system 1000 may include, instead of the first user terminal 200 and the second user terminal 300, a user terminal in which the functions of the first user terminal 200 and those of the second user terminal 300 are integrated.

Further, in the above-described example embodiment, the personal information acquisition unit 142 of the server 100 or 100a acquires the personal information of the user U and the companion (hereinafter also referred to as the user and the like) from the user terminal such as the second user terminal 300. However, the personal information acquisition unit 142 may instead acquire the personal information from an external apparatus that is connected to the network N and stores part or all of personal information of the user and the like.

For example, the external apparatus may operate a schedule management application and accumulate pieces of schedule information of the user and the like acquired through such operations. Then, the external apparatus may transmit the user ID and the schedule information to the server 100 through the network N at a predetermined timing. Further, for example, the external apparatus may operate an application for managing a purchase history and store purchase histories of the user and the like acquired through such operations.

Further, a face authentication terminal may be installed in each facility, and when the user and the like visit a facility, the face authentication terminal may transmit the user ID and a visit history to the server 100 or 100a through the network N. Then, the server 100 or 100a may register the visit history as a behavior history in the user DB 112 while associating it with the user ID.

Further, a face payment terminal may be installed in each facility, and when a user or the like makes a payment at a store, the face settlement terminal transmits the user ID and the payment history to the server 100 or 100a through the network N. Then, the server 100 or 100a may register the payment history as a purchase history in the user DB 112 while associating it with the user ID.

Further, in the above-described example embodiment, the server 100 or 100a detects an element of interest from a photographed image and provides output information to the first user terminal 200. In addition to this, the server 100 or 100a may determine whether the user U is approaching an element of interest based on the position information of the user U. Then, when it is determined that the user U has approached the element of interest, the server 100 or 100a may make (e.g., instruct) the first user terminal 200 output introduction information for introducing output information or advertisement information of the element of interest. Note that the server 100 or 100a may determine that the user U has approached an element of interest when the distance between the position of the user U and the position of the element of interest is within a predetermined threshold, or when the aforementioned distance is within a predetermined threshold and the element of interest is located in the direction in which the user U is traveling. Further, the method for outputting introduction information or advertisement information may be to display it, or may be a voice output. For example, the server 100 or 100a may make (e.g., instruct) the first user terminal 200 output a voice or a speech expressing a message “You are almost at the exhibition space for the element of interest. Video contents will be played”.

The whole or part of the example embodiments disclosed above can be described as, but not limited to, the following supplementary notes.

### (Supplementary Note 1)

An information processing apparatus comprising:
selecting means for selecting one of a plurality of operating modes according to a predetermined condition;
image acquisition means for acquiring a photographed image generated by photographing a user's view by a user terminal;
element-of-interest detection means for detecting a predetermined element of interest in the photographed image;
generation means for generating superimposition information related to the element of interest at least based on identification information of the element of interest and a type of the selected operating mode; and
output control means for making the user terminal display the superimposition information in such a manner that the superimposition information overlaps a view area indicating the user's view.

### (Supplementary Note 2)

The information processing apparatus described in Supplementary note 1, wherein
the selecting means:
acquires contract information about a contract with the user; and
selects one of the operating modes according to the contract information.

### (Supplementary Note 3)

The information processing apparatus described in Supplementary note 1 or 2, wherein
the output control means makes the user terminal display a selection receiving image so that it overlaps the view area,
the information processing apparatus further comprises operation detection means for detecting an operation for selecting the selection receiving image performed by the user based on a position of a hand of the user in the photographed image and a position at which the selection receiving image is superimposed in the view area, and
the selecting means changes the operating mode in response to the detection of the selecting operation.

### (Supplementary Note 4)

The information processing apparatus described in any one of Supplementary notes 1 to 3, wherein the superimposition information related to the element of interest includes image information representing a person, an object, a building, or a landscape related to the element of interest, or an avatar of a guide person who explains the element of interest.

### (Supplementary Note 5)

The information processing apparatus described in any one of Supplementary notes 1 to 4, wherein the generation means generates voice output information related to the element of interest at least based on identification information of the element of interest in at least one of the plurality of operating modes.

### (Supplementary Note 6)

The information processing apparatus described in any one of Supplementary notes 1 to 5, further comprising personal information acquisition means for acquiring personal information of at least one of the user and a companion of the user, wherein
the generation means generates the superimposition information based on identification information of the element of interest and the personal information in at least one of the plurality of operating modes.

### (Supplementary Note 7)

The information processing apparatus described in Supplementary note 6, wherein the personal information includes at least one of attribute information, position information, a behavior history, a purchase history, and schedule information.

### (Supplementary Note 8)

The information processing apparatus described in Supplementary note 6 or 7, wherein the generation means determines an expression mode of a person, an object, a building, or a landscape related to the element of interest, or an avatar of a guide person who explains the element of interest based on the personal information, and generates the superimposition information based on the determined expression mode.

### (Supplementary Note 9)

The information processing apparatus described in any one of Supplementary notes 6 to 8, wherein
the personal information acquisition means acquires personal information of the user, personal information of the companion, and a degree of importance of the personal information of the companion relative to that of the personal information of the user, and
the generation means generates the superimposition information based on personal information of the user, personal information of the companion, and the degree of importance.

### (Supplementary Note 10)

The information processing apparatus described in any one of Supplementary notes 6 to 9, wherein the generation means generates voice output information related to the element of interest based on identification information of the element of interest and the personal information in the at least one of the operating modes.

### (Supplementary Note 11)

The information processing apparatus described in any one of Supplementary notes 1 to 10, wherein
the plurality of operating modes include a plurality of operating modes in which types of output information to be output from the user terminal are different from one operating mode to another, and
the output information of each of the plurality of operating modes includes at least one of a pair of superimposition information and voice output information based on a non-interactive process, and a pair of superimposition information and voice output information based on an interactive process.

### (Supplementary Note 12)

An information processing system comprises:
a user terminal used by a user and configured to photograph a user's view; and
an information processing apparatus, wherein
the information processing apparatus includes:
selecting means for selecting one of a plurality of operating modes according to a predetermined condition;
image acquisition means for acquiring a photographed image generated by the user terminal;
element-of-interest detection means for detecting a predetermined element of interest in the photographed image;
generation means for generating superimposition information related to the element of interest at least based on identification information of the element of interest and a type of the selected operating mode; and
output control means for making the user terminal display the superimposition information in such a manner that the superimposition information overlaps a view area indicating the user's view.

### (Supplementary Note 13)

An information processing method comprising:
selecting one of a plurality of operating modes according to a predetermined condition;
acquiring a photographed image generated by photographing a user's view by a user terminal;
detecting a predetermined element of interest in the photographed image;
generating superimposition information related to the element of interest at least based on identification information of the element of interest and a type of the selected operating mode; and
making the user terminal display the superimposition information in such a manner that the superimposition information overlaps a view area indicating the user's view.

### (Supplementary Note 14)

A non-transitory computer readable medium storing a program for causing a computer to perform:
a selection process for selecting one of a plurality of operating modes according to a predetermined condition;
an image acquisition process for acquiring a photographed image generated by photographing a user's view by a user terminal;
an element-of-interest detection process for detecting a predetermined element of interest in the photographed image;
a generation process for generating superimposition information related to the element of interest at least based on identification information of the element of interest and a type of the selected operating mode; and
an output control process for making the user terminal display the superimposition information in such a manner that the superimposition information overlaps a view area indicating the user's view.

### REFERENCE SIGNS LIST

10 INFORMATION PROCESSING APPARATUS
11, 141 SELECTING UNIT
13, 143 IMAGE ACQUISITION UNIT
14, 144 ELEMENT-OF-INTEREST DETECTION UNIT
15, 145 GENERATION UNIT
16, 146 OUTPUT CONTROL UNIT
100, 100a SERVER (INFORMATION PROCESSING APPARATUS)
110, 110a STORAGE UNIT
111, 111a PROGRAM
112 USER DB
1121 USER ID
1122 PERSONAL INFORMATION
1123 CONTRACT INFORMATION
113 ELEMENT DB
1131 ELEMENT ID
1132 ELEMENT FEATURE INFORMATION
1133 ELEMENT-RELATED INFORMATION
1134 BASIC IMAGE INFORMATION
1135 BASIC VOICE INFORMATION
1136 EDITING INFORMATION
120 MEMORY
130 COMMUNICATION UNIT
140, 140a CONTROL UNIT
142 PERSONAL INFORMATION ACQUISITION UNIT
147 OPERATION DETECTION UNIT
200 FIRST USER TERMINAL
210 CAMERA
220 STORAGE UNIT
230 COMMUNICATION UNIT
240 DISPLAY UNIT
245 VOICE OUTPUT UNIT
250 INPUT UNIT
260 CONTROL UNIT
300 SECOND USER TERMINAL
310 CAMERA
320 STORAGE UNIT
330 COMMUNICATION UNIT
340 DISPLAY UNIT
350 INPUT UNIT
360 CONTROL UNIT
400, 410, 415, 430 SUPERIMPOSITION IMAGE
420 SELECTION RECEIVING IMAGE
600 HAND AREA
1000 INFORMATION PROCESSING SYSTEM
U USER
N NETWORK
T ELEMENT OF INTEREST
V PHOTOGRAPHED IMAGE

What is claimed is:

1. An information processing apparatus comprising:
at least one memory storing instructions, and
at least one processor configured to execute the instructions to;
select one of a plurality of operating modes according to a predetermined condition;
acquire a photographed image generated by photographing a user's view by a user terminal;
detect a predetermined element of interest in the photographed image;
generate superimposition information related to the element of interest at least based on identification information of the element of interest and a type of the selected operating mode; and
make the user terminal display the superimposition information in such a manner that the superimposition information overlaps a view area indicating the user's view.

2. The information processing apparatus according to claim 1, wherein the at least one processor configured to execute the instructions to:
acquire contract information about a contract with the user; and
select one of the operating modes according to the contract information.

3. The information processing apparatus according to claim 1, wherein
the at least one processor configured to execute the instructions to make the user terminal display a selection receiving image so that it overlaps the view area,
the at least one processor configured to further execute the instructions to:
detect an operation for selecting the selection receiving image performed by the user based on a position of a hand of the user in the photographed image and a position at which the selection receiving image is superimposed in the view area, and
change the operating mode in response to the detection of the selecting operation.

4. The information processing apparatus according to claim 1, wherein the superimposition information related to the element of interest includes image information representing a person, an object, a building, or a landscape related to the element of interest, or an avatar of a guide person who explains the element of interest.

5. The information processing apparatus according to claim 1, wherein the at least one processor configured to execute the instructions to generate voice output information related to the element of interest at least based on identification information of the element of interest in at least one of the plurality of operating modes.

6. The information processing apparatus according to claim 1, the at least one processor configured to further execute the instructions to acquire personal information of at least one of the user and a companion of the user, wherein
the at least one processor configured to execute the instructions to generate the superimposition information based on identification information of the element of interest and the personal information in at least one of the plurality of operating modes.

7. The information processing apparatus according to claim 6, wherein the personal information includes at least one of attribute information, position information, a behavior history, a purchase history, and schedule information.

8. The information processing apparatus according to claim 6, wherein the at least one processor configured to execute the instructions to determine an expression mode of a person, an object, a building, or a landscape related to the element of interest, or an avatar of a guide person who explains the element of interest based on the personal information, and generate the superimposition information based on the determined expression mode.

9. The information processing apparatus according to claim 6, wherein
the at least one processor configured to execute the instructions to:
acquire personal information of the user, personal information of the companion, and a degree of importance of the personal information of the companion relative to that of the personal information of the user, and
generate the superimposition information based on personal information of the user, personal information of the companion, and the degree of importance.

10. The information processing apparatus according to claim 6, wherein the at least one processor configured to execute the instructions to generate voice output information related to the element of interest based on identification information of the element of interest and the personal information in the at least one of the operating modes.

11. The information processing apparatus according to claim 1, wherein
the plurality of operating modes include a plurality of operating modes in which types of output information to be output from the user terminal are different from one operating mode to another, and
the output information of each of the plurality of operating modes includes at least one of a pair of superimposition information and voice output information based on a non-interactive process, and a pair of superimposition information and voice output information based on an interactive process.

12. An information processing system comprises:
a user terminal used by a user and configured to photograph a user's view; and
an information processing apparatus, wherein
the information processing apparatus includes:
at least one memory storing instructions, and
at least one processor configured to execute the instructions to;
select one of a plurality of operating modes according to a predetermined condition;
acquire a photographed image generated by the user terminal;
detect a predetermined element of interest in the photographed image;
generate superimposition information related to the element of interest at least based on identification information of the element of interest and a type of the selected operating mode; and
make the user terminal display the superimposition information in such a manner that the superimposition information overlaps a view area indicating the user's view.

13. An information processing method comprising:
selecting one of a plurality of operating modes according to a predetermined condition;
acquiring a photographed image generated by photographing a user's view by a user terminal;
detecting a predetermined element of interest in the photographed image;
generating superimposition information related to the element of interest at least based on identification information of the element of interest and a type of the selected operating mode; and
making the user terminal display the superimposition information in such a manner that the superimposition information overlaps a view area indicating the user's view.

14. A non-transitory computer readable medium storing a program for causing a computer to perform:
a selection process for selecting one of a plurality of operating modes according to a predetermined condition;
an image acquisition process for acquiring a photographed image generated by photographing a user's view by a user terminal;
an element-of-interest detection process for detecting a predetermined element of interest in the photographed image;
a generation process for generating superimposition information related to the element of interest at least based on identification information of the element of interest and a type of the selected operating mode; and
an output control process for making the user terminal display the superimposition information in such a manner that the superimposition information overlaps a view area indicating the user's view.
